(19) United States
(12) Patent Application Publication
(10) Pub. No.: US 2018/0314950 A1
(43) Pub. Date: Nov. 1, 2018

(54) SYSTEM AND METHOD FOR REAL-TIME DECISIONING AND TRIGGERING OF ACTIONS IN A COMMUNICATION NETWORK

(71) Applicant: Comptel Oyj, Helsinki (FI)

(72) Inventors: Antti KOSKELA, Helsinki (FI); Mikko JARVA, Helsinki (FI); Leo WIKSTROM, Helsinki (FI)

(21) Appl. No.: 15/711,522

(22) Filed: Sep. 21, 2017

(30) Foreign Application Priority Data
Apr. 26, 2017 (MY) PI2017701461

(51) Int. Cl. G06N 5/02; G06N 99/00

(52) U.S. Cl. CPC G06N 5/022; G06N 99/005

(57) ABSTRACT

An electronic system for facilitating action decisioning in a communications network includes at least one processor configured to cause: integrating data from a plurality of data sources, the data including data indicative of occurrences of events, and data on more slowly evolving or substantially static dimensions; establishing and maintaining a digital catalog based on the integrated data that is processed to a plurality of cataloged items for constructing real-time decision logics involving one or more of the cataloged items for triggering the execution of actions; publishing the catalog for remote access; receiving a request reflecting a number of conditions included in the cataloged items for a decision logic to trigger an action, the number of indicated conditions including at least one contextual event based trigger condition; and serving the received request by issuing a trigger signal responsive to detecting fulfillment of the conditions associated with the request as determined.

### FIELD OF THE INVENTION

The invention relates to an electronic system and related method for triggering of actions in communication networks. Particularly, however not exclusively, the present invention pertains to complex event processing and related real-time decisioning including event-based triggering of actions in the communications networks.

### BACKGROUND

Event processing generally refers to deriving conclusions, such as threats and opportunities, based on detected occurrences of various events, which may in turn trigger alerts or other responses.

In the context of so-called complex event processing (CEP), a large amount of input event data is received from a plurality of sources and subsequently combined to determine events or related relationships between different instances of the obtained data. A stream processor dealing with these multiple streams of input data may be connected to a destination downstream system, such as a BSS (Business Support System), based on real-time information to provide valuable input thereto for decision-making regarding e.g. customer experience management (CEM), billing or network management such as dynamic demand control.

A multitude of triggers for initiating (triggering) the responses, or ‘actions’, may be constructed using workflow logic and/or coding, whereupon potential reuse of associated elements requires tedious selective copying of previous work results or simply recoding.

Accordingly, the complexity and maintainability of any larger number of the aforementioned trigger-based decision-making logics may rather soon become unmanageable especially in complex networking environments considering e.g. modern communication networks such as 3G, 4G and especially upcoming 5G, networks wherein millions or billions of events may be in principle monitored and used for triggering different pre-defined responses.

Further, gaining any deeper understanding underlying the existing decision-making, or simply ‘decision’, logics as well as implementing new ones may turn out difficult, if the use environment in question is as versatile as a modern communication network infrastructure unquestionably tends to be. The custom nature of dedicated logics may also require effortful case-specific integration with new systems as the needed resources are not clearly visible to an integrator. Accordingly, the applied point-to-point, or ‘one-to-one’, integrations add to the unmanageability of the overall solution.

Having regard to available high performance wireless communication networks and technologies where a multitude of CEP applications will easily find use, e.g. Long Term Evolution (LTE) is a network scheme recommended by the 3^{rd} Generation Partnership Project (3GPP). In an LTE network, all communications are, instead of more traditional circuit-switched connections, carried over an IP channel from user equipment (UE), via OFDM-based (Orthogonal Frequency Division Multiplexing) E-UTRAN (Evolved UMTS Terrestrial Radio Access Network) air interface, to an all-IP core called the Evolved Packet Core (EPC). LTE thereby represents a paradigm change between circuit switching and packet switching among several other differences.

The EPC is a multi-access core network that basically enables operators to provide a common packet core network for 3GPP radio access (LTE, 3G, and 2G), non-3GPP radio access (HRPD, WLAN, and WiMAX), as well as fixed access (Ethernet, DSL, cable, and fiber). Different interworking specifications have been issued by the 3GPP for the purpose.

The EPC thus provides gateway access to other networks, operator services, applications, the Internet, etc. while ensuring an acceptable Quality of Experience (QoE) and charging a subscriber for their particular network activity. Even though LTE is in many contexts referenced as 4G technology, the basic LTE does not as such completely fulfill the requirements originally set for 4G wireless service by ITU-R, whereupon it is often considered to fall under the “almost” 4G or “first generation 4G” category, whereas a more recent enhancement thereof named as LTE Advanced meets the requirements more literally.

Arising from a sheer number, versatility and diversity of communication network architectures, related services, associated data sources and resulting amount of data event, which may be established relying upon LTE, LTE Advanced or feasible other 3G/4G technology, for example, the afore-discussed traditional way of building and integrating ‘hard-coded’ decision logics has in several ways reached its evolutionary terminus, whereupon an alternative, cultivated approach of designing and deploying such would be highly appreciated in the field.

### SUMMARY

The objective of the present invention is to provide a solution at least alleviating one or more of the aforesaid defects and drawbacks associated with prior art arrangements in the context of communication networks and related dynamic control measures derived from obtained data indicative of, among various potential other elements, different events occurred in or at least having regard to the networks or its users.

The objective is achieved by various embodiments of a system and a method as defined in the appended claims.

In accordance with an aspect of the present invention, an electronic system for facilitating action decisioning in a communications network and related information technology having regard to its operations and business operations, optionally 4G or specifically, but not limited to, LTE based network, comprises one or more data interfaces for transferring data, at least one processor for processing instructions and other data, and memory for storing the instructions and other data, said at least one processor being configured, in accordance with the stored instructions, to cause:

integrating data from a plurality of data sources internal and/or external to the network, wherein the data includes
contextual, substantially real-time event data indicative of occurrences of events including events regarding one or more users of the network and/or taking place in or being at least detectible via the network or related system, such as call, message, data usage, application usage, service quality or location data, obtained from a number of event data sources, preferably including network elements;
data on more slowly evolving or substantially static dimensions, such as user profile data, preferably obtained from a number of batch data sources such as downstream client (e.g. BSS) system; and optionally also
action data or metadata indicative of a plurality of actions available for execution in the network or an external system functionally connected thereto,

establishing and maintaining a digital catalog based on the integrated data, the integrated data being processed, incorporating at least (preferably semantic) data abstraction, to a plurality of cataloged items for constructing real-time decision logics involving one or more of the cataloged items for triggering the execution of actions, said cataloged items including contextual event based trigger conditions and other, optional criterion type, conditions based on said more slowly evolving or substantially static dimensions,

publishing the catalog for remote access,

receiving, preferably utilizing a subscription based notification mechanism, a request indicative of a number of conditions comprised in said cataloged items for a decision logic to trigger an action, said number of indicated conditions including at least one contextual event based trigger condition and preferably at least one condition based on slowly evolving or substantially static dimensions, and

subsequently serving the received request in a substantially real-time fashion by issuing a trigger signal responsive to detecting fulfillment of the conditions associated with the request as determined based on the received, integrated data.

In some embodiments, said processing of the integrated data comprises at least one processing element selected from the group consisting of: aggregation, correlation, mapping, normalization, enrichment, counting, validation, duplicate handling, duplicate removal, and filtering. Such elements may be applied for data abstraction and/or other processing purpose preceding decision making.

In some embodiments, also action data is integrated in the system and published in the catalog. Accordingly, the request may indicate a cataloged action to be triggered responsive to the fulfillment of the conditions of the concerned decision logic (and particular action).

Thus, in some embodiments the request may substantially define more comprehensive decision logic for triggering desired action(s) while in some other embodiments the request may omit the definition of action(s) with reference to various scenarios wherein the actual linkage between a certain trigger and certain responsive action may be then made external to the triggering electronic system, optionally in a client or some other downstream system utilizing the received trigger signal for initiating the execution of the action either locally and/or respectively, in a functionally connected system.

In some embodiments, an action associated with the trigger signal and underlying, then fulfilled, conditions/criteria is executed. For example, it may be provisioned through e.g. a fulfillment system of the network. A component of the electronic system itself may itself be configured to internally receive the trigger signal and then control the execution or at least initiation of the execution of the associated action accordingly. A network element or external system may be configured so as to execute the action or at least part (e.g. sub-task(s)) thereof.

Indeed, some embodiments may involve configuration as alluded to above. In addition to or instead of configuring the electronic system to determine e.g. desired variables or indicators such as counters, or related values, from the input data for decision logic conditions or configuring a target system for related action execution, also data source(s) may be configured so as to monitor, establish and/or output desired information, e.g. contextual event data with desired characteristics, based on source data available thereat for establishing the catalog.

In some embodiments, a recommendation is determined and issued, optionally comprising inclusion in the catalog and/or publication using some other selected mechanism such as publication-subscribe type mechanism. The recommendation may comprise a trigger condition, or more comprehensive decision logic involving a number of trigger conditions and at least one action to be triggered upon fulfillment thereof. The system may be configured to apply machine learning and related analysis rules to the data provided thereto, and detect patterns and relationships among it. For example, it may notice that responsive to certain input data such as contextual event data a certain action is afterwards executed (causal relation), whereupon it may publish the detected relationship by, for instance, recommending establishing related decision logic or recommending the concerned trigger condition.

In some embodiments, the recommendation may be specifically targeted to a number of elements, e.g. to a predefined system configured to receive or handle the recommendations, a system executing the action, a system being responsible for triggering the action, and/or a system otherwise associated with the action. In related more extreme example, such recommended decision logic could be constructed and taken into use automatically; the system may be configured to enable constructing and executing decision logics autonomously depending e.g. on the related integrated data and/or action associated therewith so that not all possible logics, e.g. the ones considered more critical, can be automatically taken into use and executed, however.

In various embodiments, the contextual event data comprises at least one element selected from the group consisting of: call data, messaging data, service quality data, environmental event data (e.g. certain time or date), location data, and user (terminal) device change (e.g. upgrade to a device with enhanced/different capabilities) data.

In various embodiments, the data on more slowly evolving or substantially static dimensions comprises at least one user related element selected from the group consisting of: profile, subscription, service usage, user (terminal) device, demographics, age, address, and gender.

In various embodiments, said plurality of actions include at least one action selected from the group consisting of: transmission of a message, transmission a message to a number of users or operator of a client system, marketing campaign or related action such as issuance of related triggering signal, capacity increase, capacity decrease, increase or decrease of processing capacity, increase or decrease of data transfer capacity, (re-)allocation of processing or data transfer resources, limitation of data usage, increase or decrease of bandwidth, execution of QoS operation (e.g. (re-)prioritization of traffic or processing, or other (re-)configuration task), transmission of a notification or an alarm message, and transmission of a notification to a number of users indicative of proposed, forthcoming or executed connection setting changes.

In accordance with another aspect of the present invention, a method for facilitating action decisioning in a communications network and related information technology architecture having regard to its operations and business operations, to be performed by at least one electronic device, optionally a server computer, comprises:

integrating data from a plurality of data sources internal and/or external to the network, wherein the data includes
contextual, substantially real-time event data preferably including stream of multiple events indicative of occurrences of events including events regarding one or more users of the network and/or taking place in or being at least detectible via the network, such as call, message, data usage, application usage, service quality or location event, obtained from a number of event data sources, preferably including network elements;
data on more slowly evolving or substantially static dimensions, such as user profile data, preferably obtained from a number of batch data sources; and optionally also
action data indicative of a plurality of actions available for execution in the network or an external system functionally connected thereto,

establishing and maintaining a digital catalog based on the integrated data, wherein the integrated data is processed, incorporating utilization of at least data abstraction, to a plurality of cataloged items for constructing real-time decision logics involving one or more of the cataloged items for triggering the execution of actions, said cataloged items including contextual event based trigger conditions and other conditions based on said more slowly evolving or substantially static dimensions,

publishing the catalog for remote access,

receiving, preferably utilizing a subscription based notification mechanism, a request indicative of a number of conditions comprised in said cataloged items for a decision logic for triggering an action, said number of indicated conditions including at least one contextual event based trigger condition and preferably at least one condition based on slowly evolving or substantially static dimensions, and

subsequently serving the request in substantially real-time fashion by issuing a trigger signal responsive to detecting fulfillment of the conditions associated with the request as determined based on the received, integrated data.

The previously presented considerations concerning the various embodiments of the system may be flexibly applied to the embodiments of the method mutatis mutandis as being appreciated by a skilled person.

The utility of the present invention is a result of many contributing factors depending on each particular embodiment.

The suggested real-time trigger system for constructing and executing decision logics include sophisticated methodology to integrate, configure, abstract and publish elemental stackable contextual items or particularly, events (or a set of related events), slowly changing dimensions and action/recommendation items, which may be resourced, besides internally from the communications network, also from a number of at least communications-wise connected external systems. Such items can be flexibly orchestrated and re-orchestrated into different real-time executable decision logics.

Subsequently, the proposed system may execute the constructed decision logics including triggering the execution of actions or issuing at least related triggers (trigger signals) on real-time data streams with contextual events, referring to selected slowly changing dimensions, such as certain users fulfilling selected criteria, which may be demographic, terminal device or subscription related, for instance, so that the receiving system (subscriber/client system in preferred embodiments) may act accordingly and execute the actions. Accordingly, various aspects of operational intelligence (OI) providing analytics solution may be thus covered by the present invention among other angles.

Awkward hard-coded stream logics per trigger may be thus cleverly avoided and replaced with the suggested flexible and more comprehensible mechanism for constructing and executing a large variety of decision logics.

Preferred embodiments of the system and method in accordance with the present invention harness a subscription based notification mechanism or specifically, a publish-subscribe (pub-sub) mechanism, for offering a catalog comprising a number of the dynamically configurable triggers or more comprehensive decision logics for exploitation by interested entities such as external systems and services.

For example, a RESTful based or similar mechanism, which is preferably simple, scalable, but still powerful, may be provided for serving the related notifications to the target parties. A target entity such as application running in external system may thus subscribe to published events of interest in an effective, reliable manner.

The mechanism may incorporate a feasible transaction interface such as a bus, which may be, for instance, of fan-out type as the electronic system may be the only connected publisher, or of a broker type solution through which a number of subscribing systems (subscribers) of triggers can be notified by the publisher (electronic system). The mechanism may be fully comprised in the system or be at least partially supplied by an external, or ‘intervening’, entity.

As one outcome, the electronic system issuing the trigger signals does not have to be provided with detailed action information or at least with the overall, more comprehensive decision logic linking a number of selected conditions with some particular action(s) to be triggered by the system itself.

Instead, e.g. different downstream systems may subscribe to whatever triggers best suit their needs and upon receipt, trigger associated actions locally.

This, for its part, adds noticeably to the flexibility of the solution. Alternative solutions are based on dedicated streaming logic and typically require point to point integrations. Such contemporary solutions basically imply tree-like, essentially pre-defined structures of combinable items, whereupon adoption of new decision logic involving old or new items requires separate hard-coding, which can be conveniently omitted by the various embodiments of the present invention.

The catalog based approach suggested herein generally enables easy construction of easy to use, semantic and understandable UI's, where decision making logic utilizing published catalog items (event conditions, other conditions, actions, etc.) can be conveniently constructed by a user such as an operator of a client system e.g. in drag-and-drop or wizard (assistive UI feature) type manner, potentially published in production, monitored and then finally retired so that new more relevant logics can ultimately take their place. Accordingly, the perceived user experience may be greatly enhanced.

In various embodiments, the trigger signals may be thus configured to directly or indirectly trigger execution of actions associated therewith, or they may be configured to represent recommendations constructed based on e.g. machine learning as discussed herein, whereupon actual execution of the action may still be considered and optionally with-held by a receiving entity based on e.g. local analysis and decision-making thereat.

The potential applications of different embodiments of the present invention are likewise numerous: customer experience management, real-time marketing, fraud detection, high frequency trading, etc. in connection with (mobile) communications networks, such as 4G or 5G networks, and beyond to name a few. The suggested orchestrated design implemented by various embodiments of the present invention further enables both dynamic determination and exploitation of different trigger conditions and associated decision logics.

For example, one or more downstream applications and/or other client entities may subscribe to relevant notifications regarding e.g. churn events or fulfillment of some other network performance (e.g. QoS of call or data traffic), capability, capacity (indicative of e.g. overload or available extra capacity) and/or status related conditions, whereupon a high capacity transaction system implemented by the electronic system may serve the related trigger signals for internally or externally triggering the associated responses (actions).

Various embodiments of the present invention involve different technologies for achieving the desired functionality possibly including, but not limited, to e.g. machine learning, data abstraction, semantic data abstraction, big data processing, data analytics, complex event processing and decision and service orchestration.

Additional benefits and implications having regard to different embodiments of the present invention are discussed hereinlater in the detailed description.

The expression “a number of” may herein refer to any positive integer starting from one (1).

The expression “a plurality of” may refer to any positive integer starting from two (2), respectively.

Different embodiments of the present invention are disclosed in the attached dependent claims.

### BRIEF REVIEW OF THE DRAWINGS

Few embodiments of the present invention are described in more detail hereinafter with reference to figures, in which

FIG. 1A illustrates an embodiment of a system in accordance with the present invention and potential related use scenario.

FIG. 1B illustrates an embodiment of catalog construction and associated procedures having regard to data acquisition, receipt of data requests e.g. in the form of subscriptions, and serving of related triggers or triggering of related actions accordingly.

FIG. 1C illustrates an embodiment of serving at least contextual event based triggers via a subscription based notification mechanism.

FIG. 2 is a block diagram representing the internals of an embodiment of an electronic system comprising at least one electronic device for implementing the present invention.

FIG. 3 is a flow diagram of an embodiment of a method in accordance with the present invention.

FIG. 4 illustrates one application example of the suggested cataloging mechanism and related procedures including decision orchestration.

### DETAILED DESCRIPTION

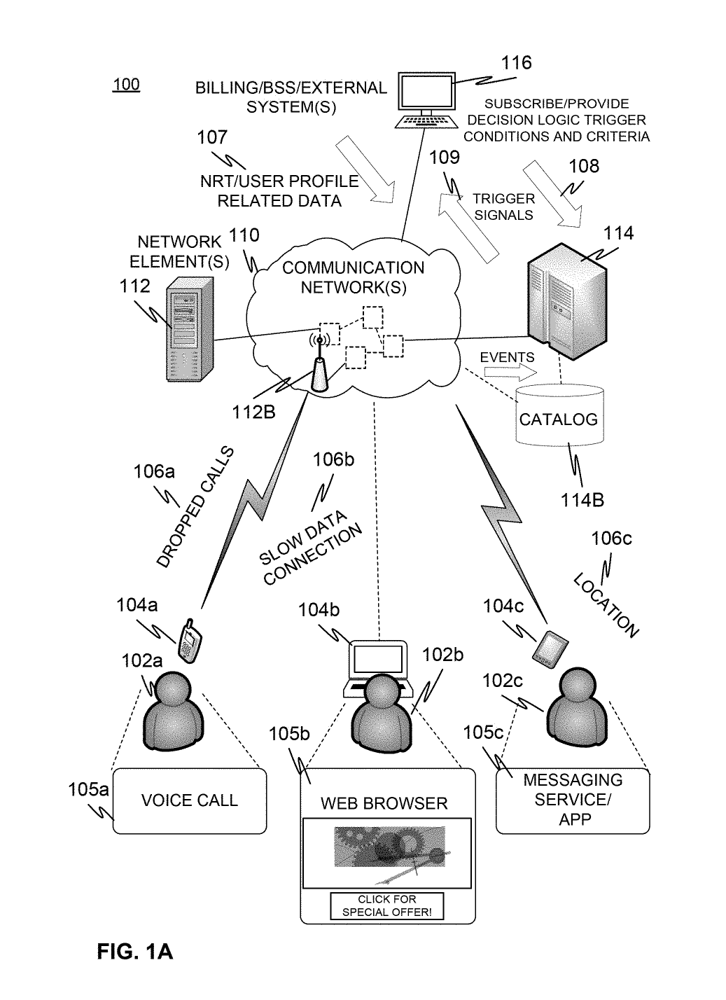

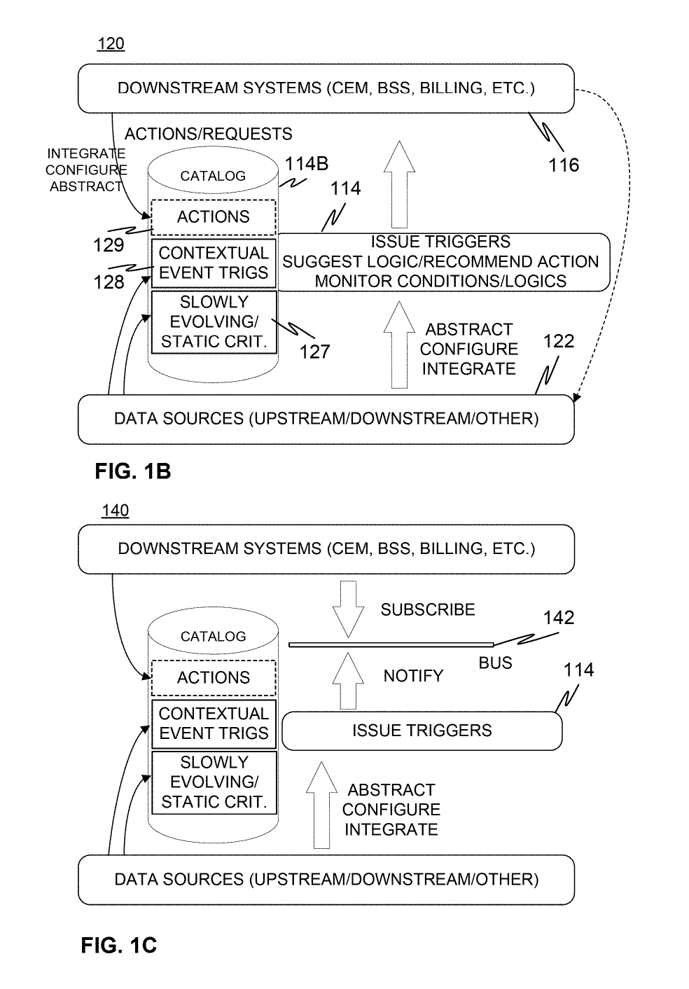

FIG. 1 shows, at 100, one merely exemplary use scenario involving an embodiment of a system 114 for action decisioning in a digital communication network 110 preferably including a telecommunications network. The network 110 may in practice include e.g. a selected 4G standard or LTE compliant network, essentially thus being or comprising a wireless or specifically mobile (telecommunications) network. It 110 may comprise at least portion of a number of access networks optionally of mutually different technology such as a radio access network (RAN), optionally E-UTRAN, with a number of base stations 112B (e.g. evolved base stations ‘eNodeB’ or ‘eNB’) and/or a fixed access network as deliberated hereinbefore. The network 110 may further comprise at least portion of a core network, optionally the aforementioned EPC.

The at least one network 110 may include a plurality of network elements (NE) 112 optionally comprising at least one element or related entity selected from the group consisting of: base station, wireless access point, eNodeB, gateway (GW), serving gateway, proxy, PDN (packet data network) GW, MME (mobility management entity), HSS (Home Subscriber Server), PCRF (policy and charging rules function) entity or server, IMS (IP multimedia subsystem), mediation system or entity such as a server, NFV MANO (management and orchestration) system or NFV entity such as a server, and fulfillment, orchestration or provisioning system or entity such as a server.

In some embodiments, a number of virtualization technologies such as NFV (network function virtualization) and generally cloud architecture may have been applied to virtualize functionalities provided by the network 110. Yet, in some embodiments, SDN (software defined network) may have been applied to separate data and control planes thereof.

In the depicted scenario of FIG. 1A, a number of users 102a, 102b, 102c (typically humans/persons) are connected to the communications network entity 110 via their user terminal devices 104a, 104b, 104c such as smartphone, computer (desktop/laptop) and tablet, respectively.

The users 102a, 102b, 102c may utilize the terminal devices 104a, 104b, 104c for various applications including but not limited to voice calls 105a and various data transfer-involving uses such as web browsing 105b or messaging 105c via different services, etc. The terminals 104a, 104b, 104c may communicate and provide data to the network 110. At least portion of the data may be conveyed either as such or in processed, such as aggregated or abstracted form, to the system 114. The terminals 104a, 104b, 104c may have been configured to execute also e.g. timed or other tasks autonomously requiring no active user intervention. As the users 102a, 102b, 102c access the network 110 via the terminals 104a, 104b, 104c and as the terminals 104a, 104b, 104c may indeed execute various network-access requiring operations autonomously, the terminals 104a, 104b, 104c could in some embodiments be considered also as the ‘users’ of the network 110, depending on a viewpoint taken.

The users 102a, 102b, 102c and related terminals 104a, 104b, 104c may be dynamically associated with a variety of different contexts and specifically, contextual events 106a, 106b, 106c, which may include events 106a indicative of e.g. dropped calls, initiation of calls, receipt of calls, generally call-related QoS type events, etc., events 106b indicative of data connection characteristics such as speed, disturbances, capacity becoming available, etc., and/or events 106c indicative of roaming/location or other, e.g. spatial or temporal, context.

The contextual event data may be gathered at a number of locations and elements, typically network elements 112, acting as data sources from the standpoint of the system 114, and provided to the system 114 as data streams.

Yet, the event data may indicate (user) terminal hardware related events such as acquisition of new terminal device 104a, 104b, 104c, which may be detected on the network side based on e.g. data provided and/or capabilities supported by the terminal.

In general, data sources providing data streams, or generally data, to the system 114 may further include besides (upstream) network elements 112 or terminals 104a, 104b, 104c also different downstream systems and entities 116 such as client/service provider systems potentially including but not limited to billing, CRM, generally BSS and/or OSS (operations support) systems and related elements.

Yet, the source data may indicate e.g. user account related data such as switchover to a new subscription type, activation of new data package, etc.

Still, the source data may indicate behavioral aspects such as the level of or change in (increase or decrease, for example) service usage or data usage.

Depending e.g. on the duration of a concerned monitoring period, such data may be considered either contextual event based (shorter time window) or more slowly evolving or substantially static (longer time window).

Indeed, in addition to contextual event based data that may be considered to be more of real-time nature with reference to e.g. a dropped call or switchover to a new subscription or terminal, non-real-time (NRT) data such as batch data on more slowly evolving or static dimensions 107 may be obtained from various sources including a number of downstream systems 116 such as the BSS. This data 107 may comprise at least one user related element selected from the group consisting of: profile, subscription, identity, service usage statistics, service preferences, roaming statistics, user (terminal) device, demographics, age, address, and gender.

Also action data indicative of actions taken and/or actions available for execution in the network 110 by the provisioning sub-system, for example, may be obtained from data sources such as the downstream systems 116.

The system 114 preferably contains and maintains a catalog 114B of trigger conditions for issuing trigger signals 109 based on the data integrated from the data sources such as network elements 112, client systems 116, and/or terminals 104a, 104b, 104c.

The system 114 may be configured to establish and publish (via the catalog 114B) applicable trigger conditions for utilization by client system(s) 116 such as event based conditions, conditions (criteria) based on more slowly evolving or substantially static dimensions or combinations thereof, automatically based on data obtained from a number data sources such as network elements 112, client system(s) 116 and optionally in some embodiments e.g. user terminals 104a, 104b, 104c.

In some embodiments, definitions of novel trigger conditions may be determined externally e.g. by (an operator of) a client system 116 and provided to the system 114 for adoption in the catalog 114B.

Following the insertion of a condition in a catalog 114B, the fulfillment of the condition may be subsequently tracked based on data integrated from the data sources. Responsive to a detected fulfillment, an associated trigger signal (if any) may be issued.

The system 114 is configured to receive subscription or generally request signals 108 from external systems and elements such as client system(s) 116, which indicate a number of e.g. event based conditions and conditions regarding more slowly evolving or static dimensions (e.g. target user profile characteristics) the fulfillment of which is in the interest of the message sender and thus to be monitored by the system 114.

Further, the requests may indicate actions to be executed or triggered for remote execution by the system 114 in or via the network 110 responsive to the detected fulfillment of the event based trigger conditions and conditions based on other, more slowly evolving or static, e.g. user profile related, dimensions.

Accordingly, in various embodiments, one or more triggering conditions or more comprehensive decision logic defining also the responsive action may comprise e.g. one or more event based conditions and one or more conditions on more slowly evolving or static dimensions such as user characteristics thus specifying the user(s) having regard to which the event based conditions are monitored. The logical operation between the conditions such as an event based condition and other condition may be ‘AND’ so that the triggering signal is only issued when both the conditions are fulfilled (e.g. a user having a specified profile has experienced the event(s) of the event based condition to a defined degree).

FIG. 1B illustrates, at 120, an embodiment of catalog construction and related features and procedures.

As contemplated hereinbefore, various data sources 122 including upstream (e.g. network elements 112) and downstream (see the dotted arrow) systems provide input data comprising contextual event data and data on more slowly evolving/static dimensions to maintain a catalog entity 114B to enable determining and detecting the fulfillment of related conditions 127, 128 that may be utilized for triggering the execution of various actions. Yet, requests indicating e.g. different trigger conditions or more comprehensive decision logics (contextual event condition(s), other criteria based on e.g. more slowly evolving/static dimensions and responsive actions) are received typically from the downstream entities, which may be the same or different than the ones providing e.g. batch type input data on more slowly evolving or static dimensions such as user profile data, with reference to e.g. a BSS system. In case the system 114 is intended to orchestrate more comprehensive decision logics involving also the actions themselves, indications of the actions 129 may be further included in the catalog 114B as selectable items of their own.

The system 114 implementing the catalog 114B as well as in some embodiments also the data sources and/or target systems receiving trigger signals or executing the triggered actions, may be adapted to execute integration, abstraction and configuration procedures based on available data.

Abstraction of data may refer to derivation of higher level (e.g. aggregated) dimensions such as variables or indicators therefrom to be used in establishing various trigger conditions, for example. Abstraction may be semantic in a sense that it works on a number of layers defining at the semantic level e.g. the context, structure, content and/or meaning of the concerned data.

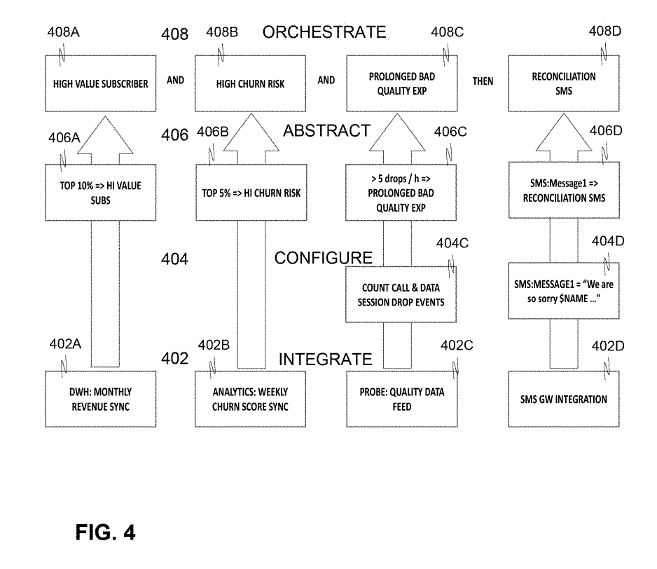

With reference to the example of FIG. 4, the system 114 integrates 402 data from a variety of data sources as contemplated hereinbefore to at least operatively establish a stacked structure of items on different functional levels of abstraction.

Item 402A refers to data obtained from a downstream system such as a BSS or specifically, a billing system. In the shown example, the data may indicate e.g. usage statistics or related revenue statistics regarding the end users of the network such as users 102a, 102b, 102c.

Item 402B refers to data received from an analytics platform on e.g. churn risk statistics regarding the users.

Both the items 402A, 402B may be thus considered non-real-time, e.g. batch type data that is more slowly evolving as it involves user profiles, which are usually somewhat static.

Item 402C refers to obtained contextual event type data indicative of e.g. service quality. Such data may be obtained from a number of network elements, for instance.

Item 402D refers to at least functional integration of target systems and elements capable of executing (responsive) actions associated with trigger conditions via the decision logics. For example, an SMS gateway could be at least functionally integrated with the system 114 for transferring SMS messages as actions determined in the corresponding decision logics. The executing element(s) or systems may be configured accordingly 404D based on the utilized configuration logic.

The data (contextual event data, data on more slowly evolving/static dimensions, indications of trigger conditions, other criteria, actions, etc.) may be generally received on different abstraction levels from the upstream and downstream systems and/or it may be abstracted to a number of levels according to selected abstraction logic by the system 114 and optionally already by the data sources.

For example, having regard to technical abstraction, selected events may be counted 404C from the obtained data with reference to e.g. call or data transfer related events, optionally e.g. calls, data consumed, or call/data connection dropouts. This may require configuring the system 114 and/or relevant data source(s) accordingly 404C.

Yet, semantically more meaningful variables, indicators or related conditions, e.g. indication of QoS (e.g. “bad quality” 406C) may be determined 406, or ‘abstracted’, based on the integrated, optionally already processed, 404 data with reference to items 406A, 406B, 406C, and 406D. Yet, e.g. different sub-populations of the userbase may be represented here 406A, 406B to target the conditions of the decision logic thereto. Likewise, higher level abstractions of related actions 406D may be utilized.

Abstraction logic and related rules linking e.g. two subsequent abstraction or generally stacked levels together may be user (client system 116)-defined (e.g. provided separately or in connection with a trigger request/decision logic definition/subscription) and/or pre-defined in the operation logic of the system 114. Yet, the abstraction logic is preferably remotely configurable by the system management or client side operators/systems 116.

As mentioned hereinbefore, the catalog and publish/notify based approach suggested herein facilitates provision of easy to use, semantic and understandable UI's for exploitation by the operators of the client systems 116, for example, among other potential users. As outcome, complex issues may be easily adopted by the users and harnessed into decision logic(s) of desired kind.

As being easily understood by a person skilled in the art based on FIG. 4, a decision logic utilizing a number of published catalog items (event conditions, other conditions such as criterion type conditions, actions, etc.) may be conveniently constructed by a user such as an operator of a client system 116, who is served with an applicable UI, which may be essentially graphical and support e.g. point-and-click, drag-and-drop or wizard (assistive UI feature) style interaction and input, including the selection of desired cataloged items for constructing the logic.

Level 408 of FIG. 4 refers to high-level decision logic and orchestration incorporating abstracted versions of the underlying items. The aforementioned UI could be configured to represent items accordingly for facilitated user selection, for example. In some embodiments, the shown level of abstraction is indeed the one on which e.g. the client systems 116 may select trigger conditions and/or more comprehensive decision logics. The catalog 114B may be established and indicated (published) accordingly to the client systems 116. The illustrated high-level items exhibit one example of possible decision logic with a number of conditions 408A, 408B, 408C and at least action 408D to be executed in response to the fulfillment of the conditions 408A, 408B, 408C. How the different condition or action items are constructed or configured having regard to different data sources, target systems, and the available data itself, is determined by the lower levels of the stacked catalog structure.

In some embodiments the logical operator between the conditions to be first fulfilled to issue a trigger signal may be the shown ‘AND’ meaning that each condition such as event based conditions and conditions on more slowly evolving or static dimensions such as essentially criteria defining e.g. characteristics of target users shall be simultaneously fulfilled to issue trigger signal for local or remote action execution.

For example, when event based condition defines a QoS related condition and a condition on more slowly evolving or static dimensions specifies a certain target user profile, the trigger signal may be issued only when a user of the specified profile faces the event based condition defined.

In some other embodiments, a number of different operators such as ‘AND’ and ‘OR’ may be separately assignable between multiple conditions for issuing a triggering signal. The request/subscription message obtained from a client system 116 may define also the desired operators.

Reverting to FIG. 1B, based on the catalog 114B established and maintained (updated, etc.), the system 114 is thus configured to issue trigger signals and directly or indirectly initiate action execution through orchestration of related services and network elements, for example.

Yet, in some embodiments the system 114 may be configured to subject data received to a number of selected procedures involving machine learning and artificial intelligence. It 114 may be configured, for example, to automatically monitor relationships among data on a number of levels, e.g. relationships between events occurred, related criteria (e.g. user profiles) and actions that have been optionally manually triggered by the network management to detect associated correlations and causalities. If e.g. an event indicative of a network related condition (e.g. spare capacity or overload/QoS problem) is first detected followed by the detection of at least associated responsive action (e.g. message sent to user(s) indicative of the capacity available for use or limitation or re-allocation of network resource usage to reduce service interruption/overload, respectively), related event condition and the action may be provided either as is or in modified (e.g. generalized/abstracted) form as a recommended decision logic. The logic may be cataloged, i.e. included in the catalog 114B. The client systems 116 may adopt these decision logics and inform the system 114 accordingly by predefined signaling such as a subscription message, for example.

Instead of or in addition to more thorough machine learning explained above, the system 114 may be just configured to detect various events occurring in the network 110 and include trigger conditions based thereon in the catalog 114B for subsequent use in connection with appropriate decision logics by the client systems 116.

FIG. 1C illustrates, at 140, an embodiment of serving contextual event based triggers via a subscription based notification mechanism or specifically a publish-subscribe(-notify) type mechanism, such as a REST based mechanism, which may be at least functionally integrated with the system 114. The mechanism may include e.g. bus type channel(s) 142 via which triggers (trigger signals) may be provided towards the client system 116.

The client systems 116 may subscribe (i.e. send a request signal) to notifications (triggers) of interest via the mechanism. The notifications are issued based on the fulfillment of the related cataloged conditions and provided to the bus or other publication channel utilized.

Depending on the embodiment, the system 114 may be configured to issue a trigger signal to an associated channel regarding a fulfillment of a number of conditions notwithstanding the number or status of subscribers thereto. Alternatively, a trigger signal may be issued only if there is a subscriber registered therefor.

Depending on the embodiment, the subscribers (client systems 116) may subscribe to action triggers and/or event/condition triggers excluding an indication of the actual action to be triggered. In the latter case, the system 114 does not even have to be aware of the possible actions executed responsive to the trigger signals externally; execution is preferably managed by the client systems 116 or other external parties.

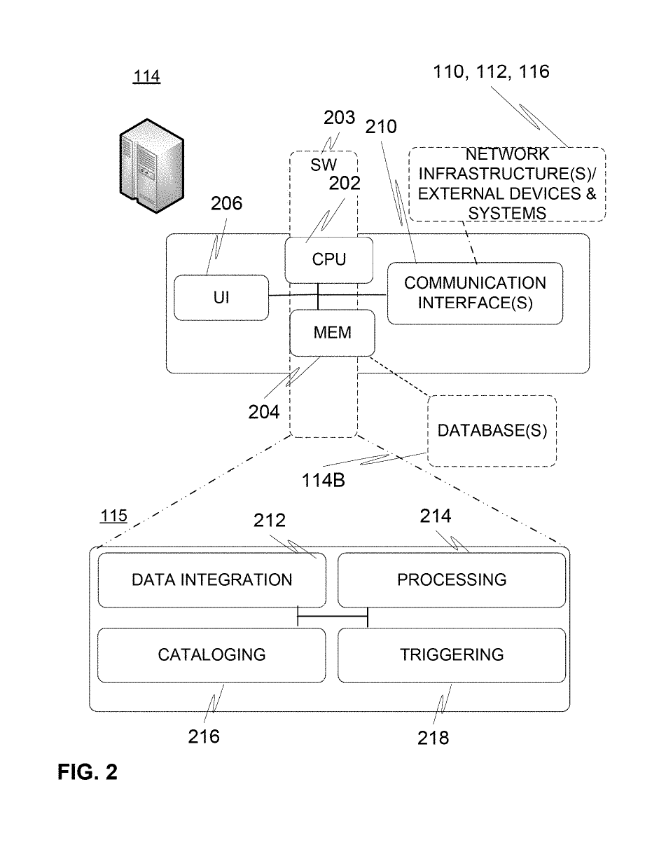

FIG. 2 is a block diagram representing the internals of an embodiment of an electronic system 114 comprising at least one device for implementing the present invention through execution of a related method, for instance.

The system 114 may be physically established by at least one electronic device, such as a server computer. The system 114 may, however, in some embodiments comprise a plurality of at least functionally connected devices such as servers and optional further elements, e.g. gateways, proxies, data repositories, firewalls, etc. At least some of the included resources such as servers or computing/storage capacity in general may be dynamically allocable from a cloud computing environment, for instance.

At least one processing unit 202 such as a microprocessor, microcontroller and/or a digital signal processor may be included. The processing unit 202 may be configured to execute instructions embodied in a form of computer software 203 stored in memory 204, which may refer to one or more memory chips separate or integral with the processing unit 202 and/or other elements.

The software 203 may define one or more applications for source data processing, catalog creation, serving the client systems with triggers, etc. A computer program product comprising the appropriate software code means may be provided. It may be embodied in a non-transitory carrier medium such as a memory card, an optical disc or a USB (Universal Serial Bus) stick, for example. The program could be transferred as a signal or combination of signals wiredly or wirelessly from a transmitting element to a receiving element.

One or more data repositories such as database(s) for establishing e.g. the catalog 114B of preferred structure may be established in the memory 204 for utilization and cultivation by the processing unit 202.

The UI (user interface) 206 may provide the necessary control and access tools for controlling the system and/or accessing the data gathered and processed. The UI 206 may include local components for data input (e.g. keyboard, touchscreen, mouse, voice input) and output (display, audio output), and/or remote input and output optionally via a web interface, preferably a web browser accessible interface. The system may thus host or be at least functionally connected to a web server, for instance. The UI 206 may be used by the operators of the client system(s) 116, for instance, for defining different condition based triggers or more comprehensive decision logics as discussed hereinbefore.

Accordingly, the depicted communication interface(s) 210 refer to one or more data interfaces such as wired network and/or wireless network interfaces for interfacing a number of external devices and systems with the system of the present invention for data input and output purposes. Such external entities may belong to the communications network 110 or reside outside it. The system 114 may be connected to the Internet for globally enabling easy and widespread communication therewith. It is straightforward to contemplate by a skilled person that when an embodiment of the system 114 comprises a plurality of functionally connected devices, any such device may contain a processing unit, memory, and e.g. communication interface of its own (for mutual and/or external communication).

Primarily from a functional standpoint, see the lower block diagram at 115, the system 114 may comprise e.g. a data integration module 212 for interfacing with various external elements and systems from which data is obtained and adopted in the catalog 114B.

Further, a processing module 214 may be included to take care of various data abstraction and generally processing tasks such as aggregation, filtering, correlation, etc.

Cataloging/publishing module 216 maintains the catalog 114B offered to external entities such as client systems 116 for trigger event (condition) and decision logic publishing and determination purposes, for example.

Still, a triggering module 218 may take care of assessing the fulfillment of triggering conditions and supply the related trigger signals, optionally incorporating also triggering of responsive actions as discussed hereinearlier, to external elements, preferably via a suggested subscription-based notification mechanism.

The triggering module 218 or e.g. the cataloging module 216 may store trigger conditions or more comprehensive decision logics involving a number of cataloged condition items and responsive action, based on which the trigger signals are issued. Definitions of new trigger conditions or decision logics may be received externally or generated internally based on pre-defined rules or machine learning, for example.

The modules 212, 214, 216, 218 are at least functionally connected together as indicated by the connecting lines in the figure.

Having regard to different embodiments of the modules, a person skilled in the art will appreciate the fact that the above modules and associated functionalities may be realized in a number of ways. A module may be divided to functionally even smaller units or two or more modules may be integrated to establish a larger functional entity. In case the system 114 comprises several at least functionally connected devices, the modules may be executed by dedicated one or more devices or the execution may be shared, even with dynamic allocation, among multiple devices (e.g. in a cloud computing environment).

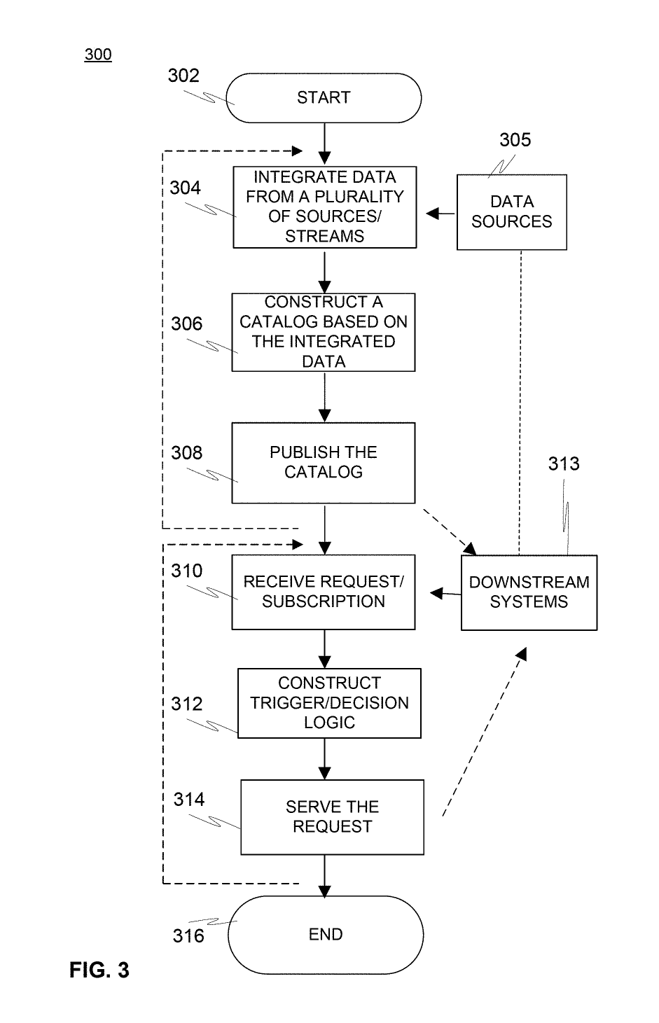

FIG. 3 shows, at 300, a flow diagram of an embodiment of a method in accordance with the present invention.

At 302, referring to a start-up phase, the necessary preparatory actions are executed. The system hardware, such as at least one server apparatus with sufficient data processing, storage and communication capabilities, may be acquired and set up by loading it with appropriate control software. The communication connections relative to e.g. network elements and external systems may be established and tested. Run-time parameters and analysis logic may be determined.

At 304, data is received from a plurality of data sources 305 internal and/or external to the network.

The data comprises contextual, substantially real-time event data indicative of occurrences of events including events regarding one or more users of the network and/or taking place in or being at least detectible via the network, such as call, message, data usage, application usage, service quality or location data, obtained from a number of event data sources, etc. The data sources 305 may include e.g. a number of network elements as explained hereinearlier.

Further, data on more slowly evolving or substantially static dimensions, such as user profile related data, is obtained from a number of e.g. batch data sources, which may refer to client systems or other downstream systems 313, at least some of which may also submit data requests having regard to trigger conditions, decision logics, etc. In other words, there may be entities involved in the method that besides providing source data also submit requests, such as subscriptions, determining e.g. trigger conditions or more comprehensive decision logics of interest.

Therefore, depending on the embodiment, also action data indicative of a plurality of actions available for execution in the network or external system functionally connected thereto may be provided to the system of the present invention for inclusion in the catalog either as is or in processed form. Accordingly, in those embodiments where the system is configured to issue condition based, such as contextual event based and e.g. user profile related criteria or other more slowly evolving/static criteria based trigger signals only, instead of associating the conditions directly with any specific responsive action to be performed within or via the communications network, receipt of such explicit action data or inclusion thereof in the catalog may be omitted.

At 306, a digital catalog is provided wherein various cataloged items may be based on the integrated data.

As contemplated hereinbefore, the integrated data may be processed, incorporating e.g. utilization of various technical and optionally additionally semantic data abstraction methods and logics (e.g. aggregation and/or mapping) and/or e.g. configuration of elements such as data sources according to higher level (more abstract) conditions or action definitions provided via the catalog, for example. Such items enable either local or remote (taking place e.g. at the client system) construction of real-time decision logics involving one or more of the cataloged items for triggering the execution of responsive actions.

Yet, in embodiments further covering action items, a number of target elements or systems executing the responsive actions may be at least functionally integrated and configured for execution of the actions triggered.

The cataloged items preferably include contextual events, or to be more accurate, contextual event based trigger conditions and preferably also other conditions, such as criteria, based on said more slowly evolving or substantially static dimensions, and optionally also actions depending on the embodiment. The cataloged items may be then utilized by client systems for triggering of desired actions.

As mentioned hereinbefore, in some embodiments the system may be configured to establish suggestions, or ‘recommendations’, e.g. on applicable conditions and/or related decision logics including also responsive actions to be taken upon fulfillment of the conditions.

At 308, the catalog is published to potential users thereof meaning the client elements and systems 313 potentially utilizing it are provided with access to the cataloged items such as conditions, actions, etc.

Yet, the client systems 313 may be offered a request mechanism 310, such as the aforementioned subscription and notification based mechanism, to indicate conditions of interest or combinations of several conditions and optionally action(s) to be executed in response to the fulfillment of the condition(s), to the system so that the system may construct and execute 312 the indicated decision logics and/or keep track of the fulfillment of the indicated conditions to be able to issue the related trigger signals 314 for executing the action triggered/executed by itself through the orchestration of network elements or services, for example, or by an external entity such as a receiving client system.

In some embodiments, an embodiment of the aforementioned UI, such as a graphical UI, may be realized to enable e.g. an operator of a client system to conveniently determine the trigger conditions or more comprehensive decision logics incorporating also the triggered actions based on the cataloged items.

The trigger signal 314 may be issued for each detected fulfillment instance of the related conditions, which may occur more or less frequently depending on the nature of the conditions. Depending on the used signaling mechanism, certain trigger signal may be issued separately (i.e. duplicated) to each subscriber or generally a party of interest, or it may be issued only once utilizing e.g. a shared notification channel among multiple subscribers.

Based on the foregoing, a person skilled in the art will acknowledge the fact that in some embodiments e.g. the construction of trigger logic 312 may be executed autonomously without necessarily first receiving a related request or other indication from a client system 313, and made then available for subscription or generally use by the client system 313.

At 316, the method execution is ended.

The dotted loop-back arrows reflect the likely repetitive nature of various method items when executed in different real-life and potentially also substantially real-time scenarios wherein new event data, batch data, data requests/subscriptions may be received substantially continuously or intermittently, and the system may repeatedly perform tasks such as integration, publishing, issuance of trigger signals, etc. without substantial delay.

1. Electronic system (114) for facilitating action decisioning in a communications network (110), said system comprising one or more data interfaces (210) for transferring data, at least one processor (202) for processing instructions and other data, and memory (204) for storing the instructions and other data, said at least one processor being configured, in accordance with the stored instructions, to cause:
integrating (212) data from a plurality of data sources (112, 116, 122) internal and/or external to the network, wherein the data includes
contextual, substantially real-time event data indicative of occurrences of events (105d, 105e, 105f) including events regarding one or more users (102a, 102b, 102c, 104a, 104b, 104c) of the network and/or taking place in or being at least detectible via the network; and
data on more slowly evolving or substantially static dimensions (106);
establishing and maintaining (216) a digital catalog (114B) based on the integrated data, the integrated data being processed (214), incorporating at least data abstraction, to a plurality of cataloged items (127, 128, 408A, 408B, 408C) for constructing real-time decision logics (408) involving one or more of the cataloged items for triggering the execution of actions (408D), said cataloged items including contextual event based trigger conditions (127, 408C) and other conditions (128, 408A, 408B) based on said more slowly evolving or substantially static dimensions,
publishing (142) the catalog for remote access,
receiving a request (108) indicative of a number of conditions comprised in said cataloged items for a decision logic to trigger an action, said number of indicated conditions including at least one contextual event based trigger condition, and
subsequently serving the received request in a substantially real-time fashion by issuing a trigger signal (109) responsive to detecting fulfillment of the conditions associated with the request as determined based on the received, integrated data.

2. The system of claim 1, wherein the integrated data further comprises action data indicative of a plurality of actions available for execution in the network or an external system functionally connected thereto, said system being configured to include said plurality of actions in the catalog and allocate the action of the decision logic associated with said number of conditions therefrom, and further wherein said trigger signal instructs to commence execution of the action.

3. The system of claim 1, comprising a notification mechanism (142) through which the trigger signal is conveyed towards a number of systems (116) subscribed to receive notifications indicative of the fulfillment of said number of conditions.

4. The system of claim 1, wherein said processing comprises at least one processing element selected from the group consisting of: aggregation, correlation, mapping, normalization, enrichment, counting, validation, duplicate handling, duplicate removal, and filtering.

5. The system of claim 1, wherein said contextual event data comprises at least one element selected from the group consisting of: call data, messaging data, service quality data, environmental event data, time data, date data, location data, and user terminal change data.

6. The system of claim 1, wherein said data on more slowly evolving or substantially static dimensions comprises at least one user related element selected from the group consisting of: profile, subscription, identity, service usage, service preferences, roaming statistics, user device, demographics, age, address, and gender.

7. The system of claim 1, wherein said plurality of actions include at least one action selected from the group consisting of: transmission of a message, transmission a message to a number of users or an operator of a client system, capacity increase or decrease, increase or decrease of processing capacity, issuance of a signal triggering a campaign, increase or decrease of data transfer capacity, (re-)allocation of processing or data transfer resources, limitation of data usage, increase or decrease of bandwidth, execution of QoS operation, transmission of a notification or an alarm message, and transmission of a notification to a number of users indicative of proposed, forthcoming or executed connection setting changes.

8. A method (300) for facilitating action decisioning in a communications network to be performed by at least one electronic device, comprising:
integrating (304) data from a plurality of data sources internal and/or external to the network, wherein the data includes
contextual, substantially real-time event data indicative of occurrences of events including events regarding one or more users of the network and/or taking place in or being at least detectible via the network, such as call, message, data usage, application usage, service quality or location data, obtained from a number of event data sources;
data on more slowly evolving or substantially static dimensions, such as user profile data,
establishing and maintaining a digital catalog (306) based on the integrated data, wherein the integrated data is processed, incorporating utilization of at least data abstraction, to a plurality of cataloged items for constructing real-time decision logics involving one or more of the cataloged items for triggering the execution of actions, said cataloged items including contextual event based trigger conditions and other conditions based on said more slowly evolving or substantially static dimensions,
publishing (308) the catalog for remote access,
receiving (310) a request indicative of a number of conditions comprised in said cataloged items for a decision logic for triggering an action, said number of indicated conditions including at least one contextual event based trigger condition, and
subsequently serving (314) the request in substantially real-time fashion by issuing a trigger signal responsive to detecting (312) fulfillment of the conditions associated with the request as determined based on the received, integrated data.

9. (canceled)

10. A non-transitory computer readable medium on which is stored a program, which, when executed by a computer, performs the method of claim 8.

11. The electronic system of claim 1, wherein the data on more slowly evolving or substantially static dimensions comprise user profile related data, and wherein the conditions based on said more slowly evolving or substantially static dimensions are criterion type conditions, and wherein the number of indicated conditions further includes at least one condition based on slowly evolving or substantially static dimensions.

12. The electronic system of claim 11, wherein wherein the system is configured to allocate the action of the decision logic associated with said number of conditions therefrom responsive to receipt of an indication of the action in said request.

13. The electronic system of claim 12, wherein the at least one action is issuance of a signal triggering a marketing campaign.

14. The method of claim 8, wherein:
the electronic device is a server computer;
the event data sources comprise network elements;
the data on more slowly evolving or substantially static dimensions are user profile data obtained from a number of batch data sources, and the data comprises action data indicative of a plurality of actions available for execution in the network or an external system functionally connected thereto;
the receiving step is performed through utilization of a subscription based notification mechanism; and
the number of indicated conditions includes at least one condition based on slowly evolving or substantially static dimensions.

15. The system of claim 2, comprising a notification mechanism (142) through which the trigger signal is conveyed towards a number of systems (116) subscribed to receive notifications indicative of the fulfillment of said number of conditions.

16. The system of claim 2, wherein said processing comprises at least one processing element selected from the group consisting of: aggregation, correlation, mapping, normalization, enrichment, counting, validation, duplicate handling, duplicate removal, and filtering.

17. The system of claim 3, wherein said processing comprises at least one processing element selected from the group consisting of: aggregation, correlation, mapping, normalization, enrichment, counting, validation, duplicate handling, duplicate removal, and filtering.

18. The system of claim 2, wherein said contextual event data comprises at least one element selected from the group consisting of: call data, messaging data, service quality data, environmental event data, time data, date data, location data, and user terminal change data.

19. The system of claim 3, wherein said contextual event data comprises at least one element selected from the group consisting of: call data, messaging data, service quality data, environmental event data, time data, date data, location data, and user terminal change data.

20. The system of claim 4, wherein said contextual event data comprises at least one element selected from the group consisting of: call data, messaging data, service quality data, environmental event data, time data, date data, location data, and user terminal change data.

21. The system of claim 2, wherein said data on more slowly evolving or substantially static dimensions comprises at least one user related element selected from the group consisting of: profile, subscription, identity, service usage, service preferences, roaming statistics, user device, demographics, age, address, and gender.
